(19) United States
(12) Patent Application Publication
(10) Pub. No.: US 2017/0300115 A1
(43) Pub. Date: Oct. 19, 2017

(54) Pneumatic Augmented Reality Tactile Feedback Platform

(71) Applicant: Northeastern University, Boston, MA (US)

(72) Inventors: Sean KERR, Boston, MA (US); Theodore STODDARD, Lincoln, MA (US); Neil DAVE, Boston, MA (US); Alejandro RAMIREZ, Boston, MA (US); Amery CONG, Malden, MA (US); Bahram SHAFAI, Wellesley, MA (US)

(21) Appl. No.: 15/486,620

(22) Filed: Apr. 13, 2017

Related U.S. Application Data
(60) Provisional application No. 62/322,020, filed on Apr. 13, 2016.

(51) Int. Cl. G06F 3/01; G08B 6/00

(52) U.S. Cl. CPC G06F 3/016; G08B 6/00

(57) ABSTRACT

The present invention provides devices, systems and methods for providing a user with haptic feedback, thus connecting the user with a virtual or remote environment. The device includes a plurality of fluid compartments that can be expanded or collapsed to provide tactile sensations to a user. The device design can provide continuous, dynamic and variable feedback that allows a user to distinguish between different virtual objects. The invention provides enhanced spatial and temporal resolution, hence providing more realistic sensory feedback and allowing for immersion into virtual or augmented reality environments.

### CROSS REFERENCE TO RELATED APPLICATIONS

This application claims priority under 35 §119(e) of U.S. Provisional Application No. 62/322,020, filed on Apr. 13, 2016, entitled “Pneumatic Augmented Reality Tactile Feedback Platform,” the disclosure of which is hereby incorporated by reference.

### BACKGROUND

Virtual reality (VR) and augmented reality (AR) applications still rely essentially on visual-only interfaces. The lack of tactile or haptic feedback often disrupts the immersive experience of VR/AR and limits the scope and functionality of current VR products such as Oculus Rift, Leap Motion, and Microsoft Kinect. In the absence of haptic feedback, the user responds to virtual collisions with a significant delay, impairing physics-based aspects of the VR application and frustrating the user.

Haptic feedback (or haptics) refers to the use of the sense of touch in an interface with the purpose of conveying information to a user or operator. Haptics technology can involve simulation of the sense of touch with different mechanisms, vibration being by far the most common. Vibrotactile stimulation is now ubiquitous, being employed in a wide range of applications from smartphones and videogame controllers to robotic operators. However, products that offer vibrational feedback do not accurately simulate real-life haptic experiences due to the lack of truly continuous feedback for the user.

Cost-effective and realistic alternatives to replace older vibrotactile-based feedback technology are lacking. CyberGrasp is a wearable haptic device that offers resistive feedback by using motors to tension cables attached to each finger. It provides high resolution feedback only at the fingertips, in addition to being bulky, heavy and exceedingly expensive, making it not only uncomfortable to use but also unfeasible as a commercial product. Moreover, it provides only limited software integration.

Air-based tactile feedback solutions for VR environments can be cost-effective, but pneumatic tactile feedback devices to date have faced challenges with bulky structure and low resolution in time and space.

Ombrellaro (US 20080153590) describes a pneumatic wearable gaming vest including a plurality of valve-controlled pneumatic bladders controlled by a computer. However, the invention is bulky, noisy, has low spatial resolution and requires the use of external compressed air tanks.

Goetgeluck (US 20160296838) discloses a haptic feedback glove for VR employing large air bladders, including one bladder for each finger. Due to the relatively large size of the air bladders, the invention offers limited spatial resolution. It also fails to offer realistic haptic feedback due to low temporal resolution and dichotomous activation of the bladders, which are either “on” or “off”.

There is ongoing need for haptic feedback devices that offer time and spatial resolution required for realistic sensory experiences, and that are also cost-effective, lightweight and scalable.

### SUMMARY OF THE INVENTION

One aspect of the invention is a haptic feedback device including a wearable article including a substrate disposed to be worn by a user; and a plurality of fluid compartments disposed on the substrate to independently exert a variable pressure on the user, each fluid compartment including a port connectable for fluid communication to a variable pressure source.

In some embodiments, the variable pressure source includes a high pressure reservoir and a lower pressure reservoir.

In some embodiments, the device further includes a pressure sensor associated with each of the fluid compartments to sense a fluid pressure within each of the fluid compartments.

In some embodiments, the device further includes one or more actuators in communication with the variable pressure source and operative to supply and remove a fluid from each fluid compartment.

In some embodiments, the device further includes a controller in communication with a plurality of pressure sensors associated with each fluid compartment, and configured to control a flow of fluid from the variable pressure source into and out of each fluid compartment to vary pressure within each fluid compartment.

In some embodiments, the fluid is a gas. In some embodiments, the fluid is air. In some embodiments, the fluid is water, oil, a polymer or any other suitable fluid.

In some embodiments, the wearable article is a glove, a vest, a cap, a helmet, or a body suit.

Another aspect of the invention is a haptic feedback device including a wearable article including a substrate disposed to be worn by a user, a plurality of fluid compartments disposed on the substrate to exert a variable pressure on the user; one or more fluid pathways disposed between each of the fluid compartments and a fluid source; a plurality of pressure sensors, each pressure sensor associated with one of the fluid compartments to sense a fluid pressure within the associated fluid compartment; an actuating mechanism in communication with the fluid source and operative to supply and remove a fluid from each fluid compartment through the one or more fluid pathways; and a controller in communication with the actuating mechanism and the plurality of pressure sensors associated with each fluid compartment, the controller configured to control a flow of fluid from the fluid source into and out of each fluid compartment to vary pressure within each fluid compartment.

In some embodiments, the device further includes a fluid source, wherein the fluid source includes a variable pressure source in fluid communication with each of the fluid compartments. In some embodiments, the variable pressure source includes a high pressure reservoir containing fluid at a first pressure and a low pressure reservoir containing a fluid at a second pressure lower than the first pressure. In some embodiments, the variable pressure source includes a high pressure fluid reservoir disposed to provide a fluid to one or more of the fluid compartments to increase pressure therein, and a low pressure fluid reservoir disposed to receive fluid from one or more of the fluid compartments to decrease pressure therein.

In some embodiments, the one or more fluid pathways are in communication with an ambient environment to supply air to and remove air from the fluid compartments. In some embodiments, the actuating mechanism includes valving disposed on a fluid pathway downstream of the high pressure fluid reservoir and actuatable to allow fluid to flow into one or more of the fluid compartments, and valving disposed on a fluid pathway upstream of the low pressure fluid reservoir and actuatable to allow fluid to flow out of one or more of the fluid compartments. In some embodiments, the controller is configured to actuate the valving for a time determined to increase or decrease pressure in one of the fluid compartments, and to check a pressure reading in the fluid compartment to determine if a desired pressure has been reached. In some embodiments, the valving includes a plurality of one-way valves or three-way valves.

In some embodiments, the actuating mechanism includes one or more pumps in communication with the fluid source. In some embodiments, the actuating mechanism includes one or more solenoids associated with each of the fluid compartments. In some embodiments, the actuating mechanism is operative to supply and remove a fluid from each fluid compartment within no more than 50 milliseconds, no more than 30 milliseconds, no more than 20 milliseconds, or no more than 10 milliseconds.

In some embodiments, the controller is operative to control the actuating mechanism to supply and remove a fluid from each fluid compartment within no more than 50 milliseconds, no more than 30 milliseconds, no more than 20 milliseconds, or no more than 10 milliseconds.

In some embodiments, the controller is in communication with a source of haptic feedback data, the haptic feedback data including at least data indicative of an external pressure change on the user, and the controller is operative to vary pressure within one or more of the fluid compartments to correspond to the external pressure change. In some embodiments, the external pressure change is a virtual pressure change. In some embodiments, the controller is in communication with a source of haptic feedback data, the haptic feedback data including data from a motion sensing device that tracks motion of the wearable article.

In some embodiments, the system further includes a fluid within the fluid compartments, wherein the fluid is a gas. In some embodiments, the gas is air. In some embodiments, the system further includes a fluid within the fluid compartments, wherein the fluid is a liquid, such as water.

In some embodiments, the plurality of fluid compartments includes at least 12 fluid compartments.

In some embodiments, the wearable article is a glove, a vest, a cap, a helmet, or a body suit. In some embodiments, the wearable article is a glove, and the fluid compartments are disposed on fingers and a palm of the glove.

Another aspect of the invention is a haptic feedback system including: a computing device configured to generate haptic feedback data; a wearable article including a substrate disposed to be worn by a user, a plurality of fluid compartments disposed on the substrate to exert a variable pressure on the user; one or more fluid pathways disposed between each of the fluid compartments and a fluid source; a plurality of pressure sensors, each pressure sensor associated with one of the fluid compartments to sense a fluid pressure within the associated fluid compartment; and an actuating mechanism in communication with the fluid source and operative to supply and remove a fluid from each fluid compartment through the one or more fluid pathways; and a programmable controller in communication with the actuating mechanism and the plurality of pressure sensors associated with each fluid compartment, the controller configured to control a flow of fluid from the fluid source into and out of each fluid compartment to vary pressure within each fluid compartment based on the haptic feedback data received from the computing device.

In some embodiments, the computing device is a videogame console. In some embodiments, the computing device includes a motion tracking system.

Yet aspect of the invention is a method for delivering haptic stimuli to a user, the method including: providing the haptic feedback system disclosed herein, in response to received haptic feedback data, actuating the actuating mechanism to supply a fluid to or remove a fluid from one or more of the fluid compartments to effect a variable pressure change for detection by the user.

In some embodiments, the fluid is a gas. In some embodiments, the fluid is air. In some embodiments, the fluid is water, oil, a polymer or any other suitable fluid.

In some embodiments, the wearable article is a glove, a vest, a cap, a helmet, or a body suit.

In some embodiments, the pressure change is effected in no more than 50 milliseconds, no more than 30 milliseconds, no more than 20 milliseconds, or no more than 10 milliseconds.

The invention can be further summarized in the following list of embodiments.
1. A haptic feedback device comprising:

a wearable article comprising a substrate disposed to be worn by a user; and

a plurality of fluid compartments disposed on the substrate to independently exert a variable pressure on the user, each fluid compartment including a port connectable for fluid communication to a variable pressure source.
2. The device of embodiment 1, wherein the variable pressure source comprises a high pressure reservoir and a lower pressure reservoir.
3. The device of embodiment 1, further comprising a pressure sensor associated with each of the fluid compartments to sense a fluid pressure within each of the fluid compartments.
4. The device of embodiment 1, further comprising one or more actuators in communication with the variable pressure source and operative to supply and remove a fluid from each fluid compartment.
5. The device of embodiment 1, further comprising a controller in communication with a plurality of pressure sensors associated with each fluid compartment, and configured to control a flow of fluid from the variable pressure source into and out of each fluid compartment to vary pressure within each fluid compartment.
6. The device of embodiment 1, wherein the fluid is a gas.
7. The device of embodiment 1, wherein the fluid is air.
8. The device of embodiment 1, wherein the wearable article is a glove, a vest, a cap, a helmet, or a body suit.
9. A haptic feedback system comprising:

a wearable article comprising a substrate disposed to be worn by a user, a plurality of fluid compartments disposed on the substrate to exert a variable pressure on the user;

one or more fluid pathways disposed between each of the fluid compartments and a fluid source;

a plurality of pressure sensors, each pressure sensor associated with one of the fluid compartments to sense a fluid pressure within the associated fluid compartment;

an actuating mechanism in communication with the fluid source and operative to supply and remove a fluid from each fluid compartment through the one or more fluid pathways; and

a controller in communication with the actuating mechanism and the plurality of pressure sensors associated with each fluid compartment, the controller configured to control a flow of fluid from the fluid source into and out of each fluid compartment to vary pressure within each fluid compartment
10. The system of embodiment 9, further including the fluid source, wherein the fluid source comprises a variable pressure source in fluid communication with each of the fluid compartments.
11. The system of embodiment 10, wherein the variable pressure source comprises a high pressure reservoir containing fluid at a first pressure and a low pressure reservoir containing a fluid at a second pressure lower than the first pressure.
12. The system of embodiment 10, wherein the variable pressure source comprises a high pressure fluid reservoir disposed to provide a fluid to one or more of the fluid compartments to increase pressure therein, and a low pressure fluid reservoir disposed to receive fluid from one or more of the fluid compartments to decrease pressure therein.
13. The system of embodiment 9, wherein the one or more fluid pathways are in communication with an ambient environment to supply air to and remove air from the fluid compartments.
14. The system of embodiment 9, wherein the actuating mechanism includes valving disposed on a fluid pathway downstream of the high pressure fluid reservoir and actuatable to allow fluid to flow into one or more of the fluid compartments, and valving disposed on a fluid pathway upstream of the low pressure fluid reservoir and actuatable to allow fluid to flow out of one or more of the fluid compartments.
15. The system of embodiment 14, wherein the controller is configured to actuate the valving for a time determined to increase or decrease pressure in one of the fluid compartments, and to check a pressure reading in the fluid compartment to determine if a desired pressure has been reached.
16. The system of embodiment 14, wherein the valving comprises a plurality of one-way valves or three-way valves.
17. The system of embodiment 9, wherein the actuating mechanism comprises one or more pumps in communication with the fluid source.
18. The system of embodiment 9, wherein the actuating mechanism comprises one or more solenoids associated with each of the fluid compartments.
19. The system of embodiment 9, wherein the actuating mechanism is operative to supply and remove a fluid from each fluid compartment within no more than 50 milliseconds.
20. The system of embodiment 19, wherein the actuating mechanism is operative to supply and remove a fluid from each fluid compartment within no more than 50 milliseconds, no more than 30 milliseconds, no more than 20 milliseconds, or no more than 10 milliseconds.
21. The system of embodiment 9, wherein the controller is operative to control the actuating mechanism to supply and remove a fluid from each fluid compartment within no more than 50 milliseconds.
22. The system of embodiment 21, wherein the controller is operative to control the actuating mechanism to supply and remove a fluid from each fluid compartment within no more than 50 milliseconds, no more than 30 milliseconds, no more than 20 milliseconds, or no more than 10 milliseconds.
23. The system of embodiment 9, wherein the controller is in communication with a source of haptic feedback data, the haptic feedback data including at least data indicative of an external pressure change on the user, and the controller is operative to vary pressure within one or more of the fluid compartments to correspond to the external pressure change.
24. The system of embodiment 23, wherein the external pressure change is a virtual pressure change.
25. The system of embodiment 9, wherein the controller is in communication with a source of haptic feedback data, the haptic feedback data including data from a motion sensing device that tracks motion of the wearable article.
26. The system of embodiment 9, further comprising a fluid within the fluid compartments, wherein the fluid is a gas.
27. The system of embodiment 26, wherein the gas is air.
28. The system of embodiment 9, further comprising a fluid within the fluid compartments, wherein the fluid is water.
29. The system of embodiment 9, wherein the plurality of fluid compartments comprises at least 12 fluid compartments.
30. The system of embodiment 9, wherein the wearable article is a glove, a vest, a cap, a helmet, or a body suit.
31. The system of embodiment 30, wherein the wearable article is a glove, and the fluid compartments are disposed on fingers and a palm of the glove.
32. A haptic feedback system comprising:

a computing device configured to generate haptic feedback data;

a wearable article comprising a substrate disposed to be worn by a user, a plurality of fluid compartments disposed on the substrate to exert a variable pressure on the user;

one or more fluid pathways disposed between each of the fluid compartments and a fluid source;

a plurality of pressure sensors, each pressure sensor associated with one of the fluid compartments to sense a fluid pressure within the associated fluid compartment; and

an actuating mechanism in communication with the fluid source and operative to supply and remove a fluid from each fluid compartment through the one or more fluid pathways; and

a programmable controller in communication with the actuating mechanism and the plurality of pressure sensors associated with each fluid compartment, the controller configured to control a flow of fluid from the fluid source into and out of each fluid compartment to vary pressure within each fluid compartment based on the haptic feedback data received from the computing device.
33. The system of embodiment 32, wherein the computing device is a videogame console.
34. The system of embodiment 32, wherein the computing device includes a motion tracking system.
35. A method for delivering haptic stimuli to a user, the method comprising:

providing the haptic feedback system of embodiment 6,

in response to received haptic feedback data, actuating the actuating mechanism to supply a fluid to or remove a fluid from one or more of the fluid compartments to effect a variable pressure change for detection by the user.
36. The method of embodiment 35, wherein the fluid is air.
37. The method of embodiment 35, wherein the wearable article is a glove, a vest, a cap, a helmet, or a body suit worn by the user.
38. The method of embodiment 35, wherein the pressure change is effected in no more than 50 milliseconds.
39. The method of embodiment 38, wherein the pressure change is effected in no more than 50 milliseconds, no more than 30 milliseconds, no more than 20 milliseconds, or no more than 10 milliseconds.

### BRIEF DESCRIPTION OF THE DRAWINGS

FIG. 1 shows a schematic representation of an embodiment of the device.

FIG. 2 shows a single fluid compartment according to one embodiment of the device.

FIG. 3 shows an embodiment of the device including a glove connected to actuators via pneumatic cables.

FIG. 4 shows a schematic representation of an open system embodiment of the device.

FIG. 5 shows a schematic representation of a closed system embodiment of the device including one actuator.

FIG. 6 shows a schematic representation of a closed system embodiment of the device including two actuators.

FIG. 7 shows a schematic representation of a closed system embodiment of the device that does not employ tanks.

FIG. 8 shows an embodiment of the device including an actuator connected to high and negative pressure tanks.

FIG. 9 shows an embodiment of the pneumatic drive circuit.

FIG. 10 shows a two-stage amplifier between differential pressure sensor and Arduino ADC according to one embodiment of the device.

FIG. 11 shows a flow chart for fluid compartment inflation logic according to one embodiment of the device.

FIG. 12 shows the rendering of a tracked hand in VR environment according to one embodiment of the device

FIG. 13 shows an image of a user's hand being tracked.

### DETAILED DESCRIPTION OF THE INVENTION

The present invention provides devices, systems and methods for providing a user with haptic feedback, thus connecting the user with a virtual or remote environment. The invention employs a pneumatic design to provide continuous, dynamic and variable feedback that allows a user to tactically distinguish between different virtual objects. The invention provides enhanced spatial and temporal resolution, improved pressure regulation, and greater force delivery than the devices and methods in the prior art, in addition to automated calibration.

One aspect of the invention is a device containing a plurality of fluid compartments that can be expanded or collapsed to provide tactile sensations to a user. Tactile or haptic sensations are impressed upon the user by the increase or decrease of pressure inside the fluid compartments caused by the inflation or deflation of the compartments. Any suitable fluid can be employed. The fluid can be chosen to have viscosity, density, compressibility, and/or any other property in a manner that is compatible with the intended use. In some embodiments, the fluid is water. In some embodiments, the fluid is air. In some embodiments, the fluid is a high viscosity fluid, such as an oil. In some embodiments, the fluid is a mixture of fluids.

In some embodiments, the device includes a wearable article. In some embodiments, the wearable article is a glove, a helmet, a vest or a full-body suit. In some embodiments, the device is a glove and when a user grabs an object in a virtual environment, the virtual object can appear to have a particular shape, size and weight because of the pressure being applied to different regions of the user's hand in response to the inflation or deflation of certain fluid compartments. In some embodiments, the fluid compartments can be inflated to variable levels, in order to provide a user with tactile feedback with enough spatial resolution to enable a user to distinguish between the shape and weights of different virtual objects. In some embodiments, the device provides haptic feedback that is synchronized with the events being displayed in a virtual or augmented reality environment. Such synchronization is possible due to the high temporal resolution of the device. The invention is capable of providing realistic haptic sensations because it can provide full expansion or collapse of the fluid compartments below the human tactile resolution, i.e., 50 milliseconds.

In some embodiments, thermal sensations can be impressed upon the user by the increase or decrease of temperature inside the fluid compartments.

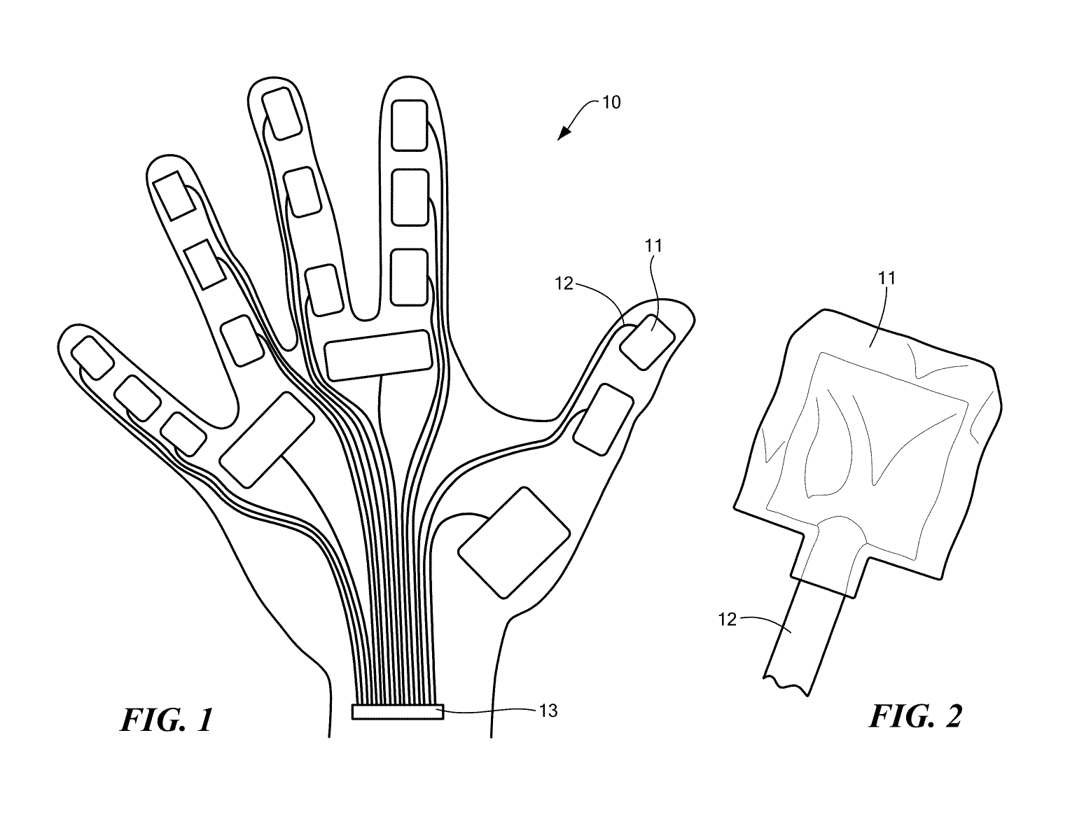

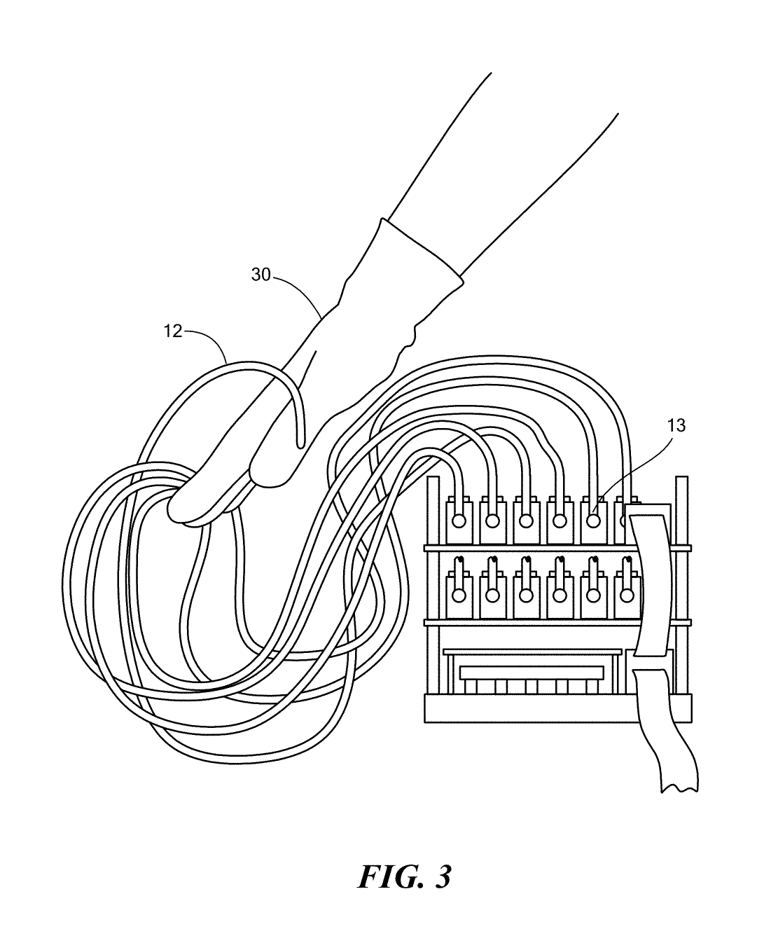

FIG. 1 shows a schematic representation of an embodiment of the haptic feedback glove 10. The glove includes a plurality of fluid compartments 11, connected by fluid cables 12 to the actuating mechanism hardware 13. The actuating mechanism can be positioned at any suitable place; for example, if the device is a haptic glove, the actuating mechanism can be placed on the dorsal surface or wrist region 13 of a haptic glove. In some embodiments, the actuating mechanism can be spaced from the wearable device. FIG. 2 shows a magnified view of one fluid compartment 11 and pneumatic cable 12. An image of a nylon glove 30 connected to the device hardware 13 via pneumatic cables 12 is shown in FIG. 3.

Wearable Article Design

The present device is scalable. The device can include as many fluid compartments as desired, and the size of each of the compartments can be scaled to accommodate different needs. For example, the compartments can have a size compatible with the actuator fluid throw, therefore ensuring imperceptible inflation of each compartment. The fluid compartments can be placed over different regions of the body. In some embodiments, the device is a wearable device and the compartments' size is adequate to convey realistic tactile sensations to the body part in contact with the device. In some embodiments, all fluid compartments have the same size. In some embodiments, at least two fluid compartments have different sizes.

The fluid compartments can be made of any material that allows for adequate elasticity and resistance. In some embodiments, the fluid compartments are made of synthetic polymers, such as polyethylene or polypropylene. In some embodiments, the fluid compartments are made of natural polymers, such as natural rubber. The compartments can be sealed using any methods known in the art, such as heat sealing. The materials of the compartments and the sealing method employed can be varied according to the application and overall system design. Leak-proof materials and sealing are desired for closed system designs, but not necessary for open system designs.

The fluid compartments can be mounted on any suitable substrates. In some embodiments, the substrate includes fabric or other woven or knitted materials. In some embodiments, the substrate is elastic to accommodate the inflation and deflation of the fluid compartments, as well as the user's movement. In some embodiments, the substrate includes an elastic synthetic polymer such as nylon, polyester, neoprene or spandex.

Fluidic Design

In some embodiments, the device includes a closed pressure system. Closed pressure systems can employ compressed air canisters, portable air tanks or other pressurized gas devices as the high pressure source. In some embodiments, the electric actuator is a push-pull solenoid. The push-pull solenoid can be used to compress air in a chamber to inflate the air pockets, with little to no latency.

Solenoids are mechanically stable and can withstand rigorous conditions with little or no damage. An example of a standard solenoid is the five or twelve volt, six newton push-pull solenoid from Trossen robotics, which offers several form factor design options. The solenoids weigh 130 grams each and minimally interfere with the user experience. In some embodiments, the solenoids used in the device can be higher voltage solenoids, thus drawing less current and improving battery life and energy use.

Solenoids have a small electrical response time, but the system could display an increased overall response time due to the time required for the solenoid to compress an appropriate amount of air. In such cases a balance can be found between the friction of the air chamber against the push of the solenoid.

The invention, however, does not require a source of pressurized fluid: the device, systems and methods of invention are functional even within an open system.

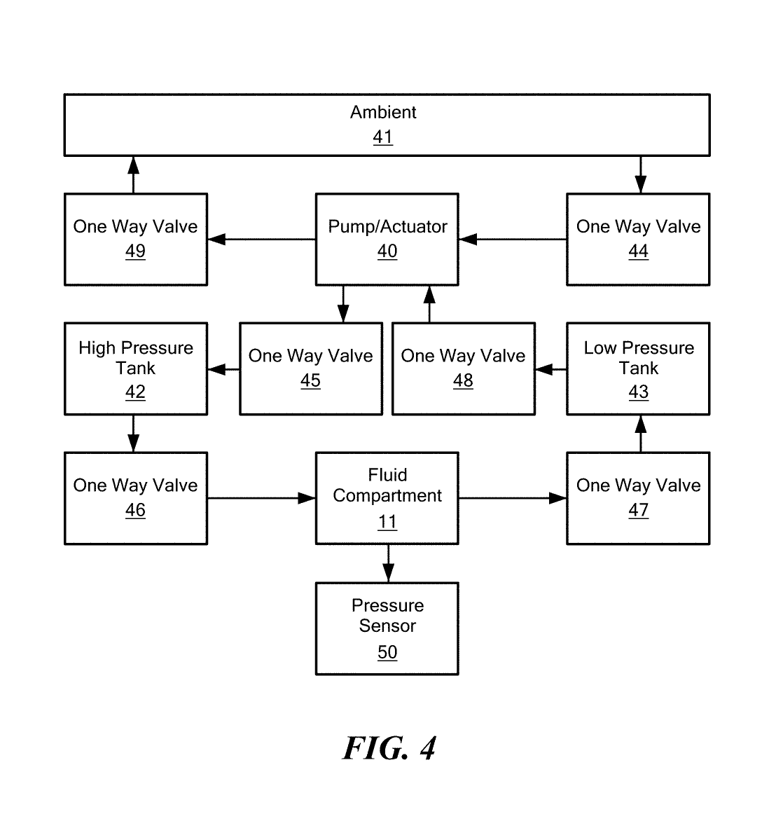

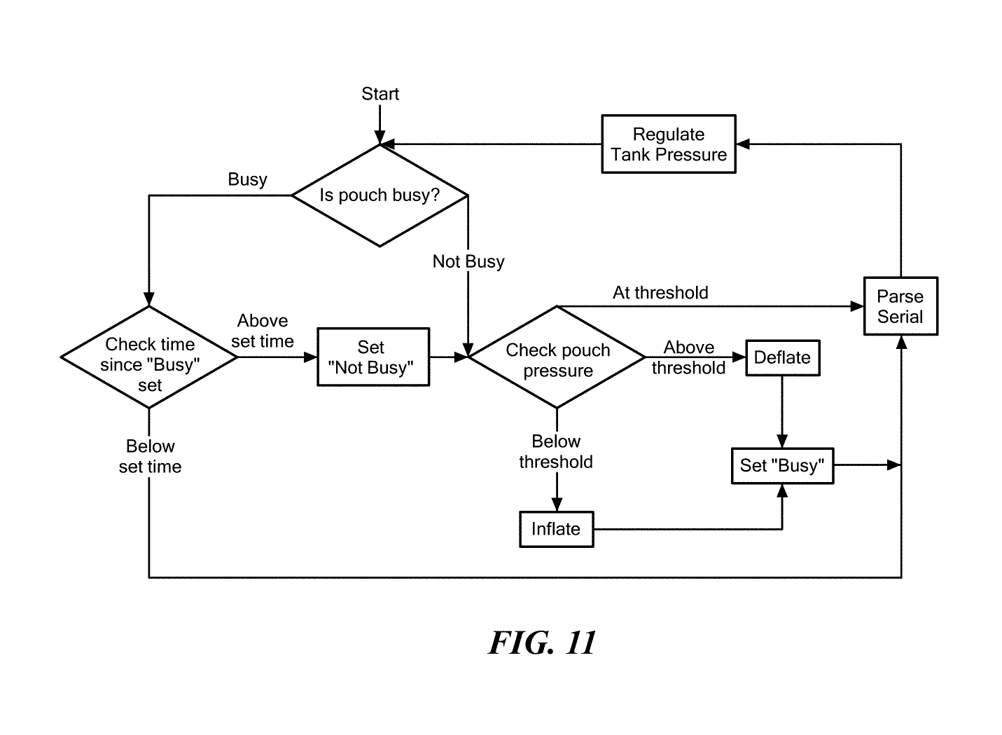

In some embodiments, the pneumatic design is an open loop system. An open loop, air-based embodiment is shown in FIG. 4. Inflation of an air compartment 11 is achieved by an actuator 40 that compresses ambient air 41 into a high pressure tank 42. An additional tank is connected to the vacuum end of the pump, thus creating a negative pressure tank 43. One or more valves are actuated to allow air to be drawn from the ambient, via valve 44, into the high pressure tank, via valve 45, and from the tank to each fluid compartment, via valve 46, for inflation in response to received haptic feedback data (e.g., a collision in a VR environment). Deflation of an air compartment 11 is obtained by the actuator 40 drawing air from the low pressure tank 43 that is in fluid communication with each fluid compartment. The air released can be recycled into the high pressure tank, or be released to environment. One or more valves are actuated to allow for air to flow out of each fluid compartment into the negative pressure tank 47, and from the tank to be drawn by the actuator, via valve 48, being then exhausted to the environment, via valve 49, or recycled back to the high pressure tank 45. Pressure sensors 50 can inform the pressure in each compartment in relation to ambient pressure. An embodiment of the open system device showing a high pressure tank 41 and a negative pressure tank 43 is shown in FIG. 11. Only one compartment is illustrated; however, any suitable number of compartments can be provided each in communication with a pressure sensor.

In order to accelerate the inflation rate of the fluid compartments, a high pressure reservoir is employed, as opposed to drawing air from the ambient directly into each compartment. In some embodiments, a high pressure tank, or positive pressure tank, can be defined as a first tank that has fluid at a first pressure, which is higher than the pressure of a second tank (i.e., the low pressure tank). In some embodiments, the pressure inside the high pressure tank is higher than the ambient pressure. In some embodiments, the fluid is air and the pressure inside the high pressure tank is higher than 14 psi, such as higher than 15 psi, higher than 20 psi, higher than 30 psi, or higher than 50 psi. Inflation can then happen faster than the 50 ms of human tactile resolution, providing the user with realistic tactile/haptic sensation. Similarly, employing a negative pressure tank provides faster deflation rates, which also fall below the human response threshold. A low pressure tank, or negative pressure tank, can be defined as a second tank that has fluid at second pressure, which is lower than the pressure of the first tank (i.e., the high pressure tank). In some embodiments, the pressure inside the low pressure tank is lower than the ambient pressure. In some embodiments, the fluid is air and the pressure inside the low pressure tank is lower than 14 psi, such as lower than 13 psi, lower than 10 psi, or lower than 5 psi. In some embodiments, the low pressure tank is a vacuum. A very fast response time can provide the user with a realistic and intuitive feeling of contact (or loss thereof) with a virtual or remote object, instead of the sensation of fluid compartments slowly inflating or deflating. Any perceptible delays in tactile sensation after visually registering an event compromise the user experience and immersion.

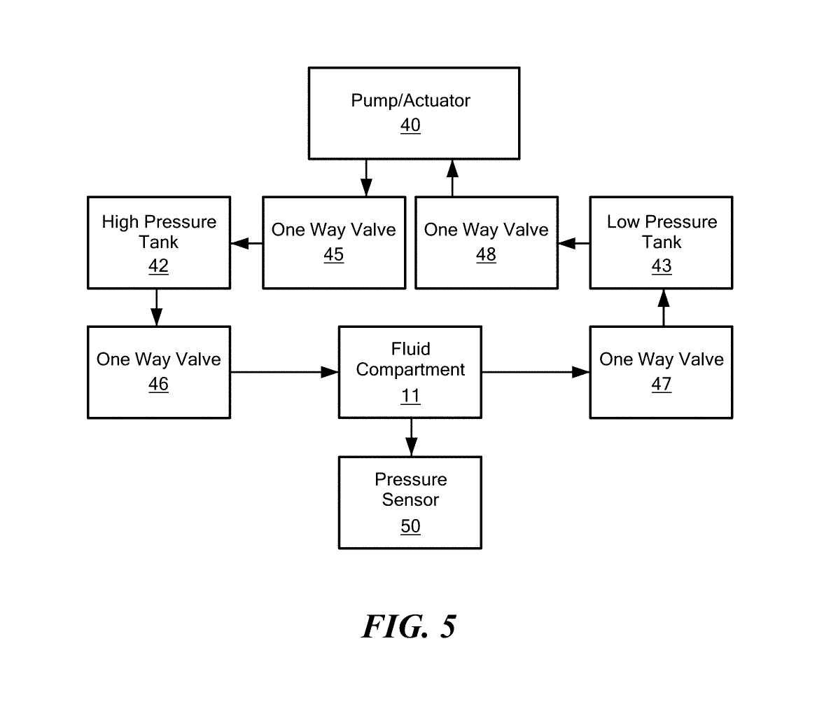

In some embodiments, the pneumatic design is a closed loop system. FIG. 5 shows an embodiment of the closed loop design including one actuator 40 that moves fluid between a low pressure tank 43 and a high pressure tank 42 to inflate or deflate each of the plurality of fluid compartments 11. The high and low pressure tanks can be any fluid reservoirs capable of maintaining the fluid at a desired pressure, including commercially available compressed gas cylinders and cartridges. Only one compartment is illustrated; however, any suitable number of compartments can be provided each in communication with a pressure sensor.

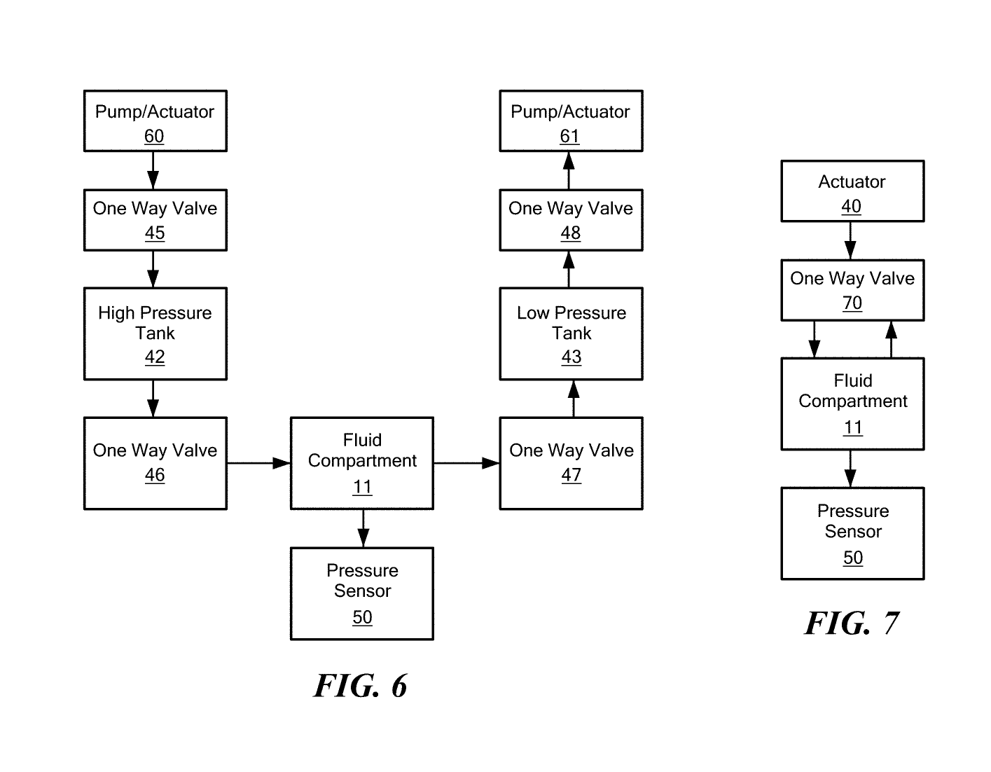

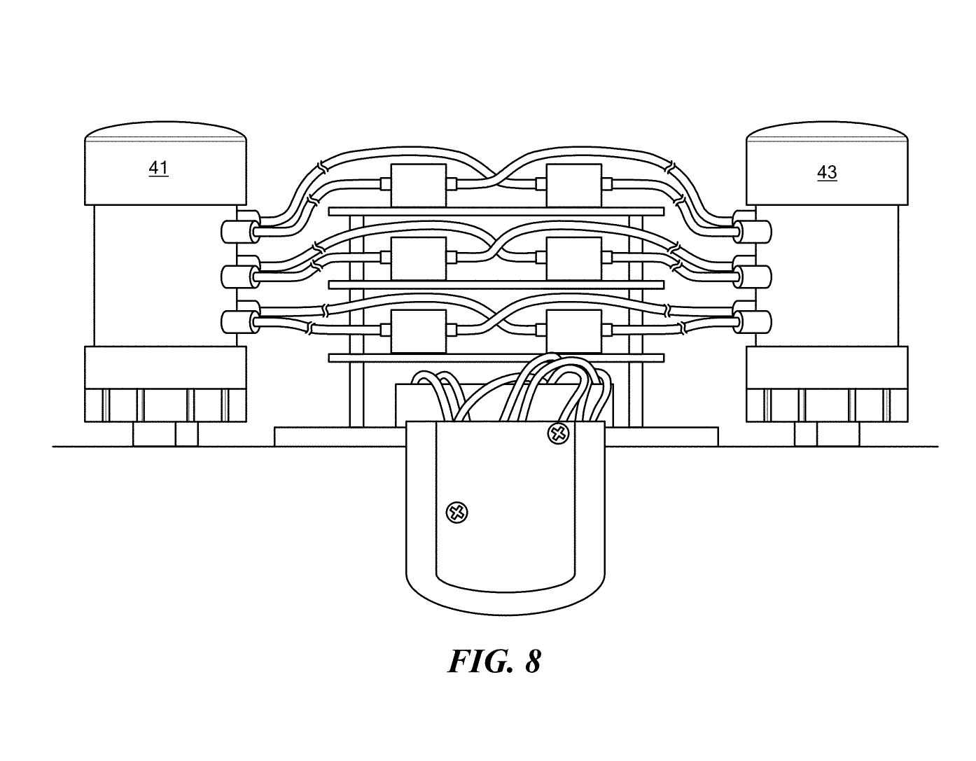

In some embodiments, the pneumatic design contains two or more actuators. Employing two or more actuators can reduce delays in the system by allowing the high pressure tank to be filled and the low pressure tank to be emptied simultaneously. FIG. 6 shows a closed loop system including a first 60 and a second 61 actuators. The actuators can be identical or different. The first actuator 60 can compress fluid into a high pressure tank 42 allowing the fluid to inflate a fluid compartment 11 to the magnitude determined by one or more pressure sensors 50. At the same time, one or more fluid compartments can be emptied by flowing fluid into the low pressure tank 43 in response to the activation of a second actuator 61. The actuators can be independently activated or deactivated. Only one compartment is illustrated; however, any suitable number of compartments can be provided each in communication with a pressure sensor.

In some embodiments the pneumatic design precludes the use of high and low pressure tanks. An actuator 40 can inflate or deflate a fluid compartment 11 by directly flowing fluid in or out of the appropriate fluid compartments. The fluid compartments that become inflated or deflated are controlled by the state of the one or more valves 70.

In some embodiments, the pump is a compressor. In some embodiments, the pump is a positive displacement pump. In some embodiments, the pump is a diaphragm pump. An example of diaphragm pump suitable for use with the invention is a 12V Parker BTC high flow miniature diaphragm pump. Any pump that can provide adequate flow rate can be employed. In some embodiments, the pump provides a flow rate of at least half of the total volume of the tanks. For example, if the tanks are designed to contain 2 L of fluid, the pump would have a flow rate of at least 1 L per minute. In some embodiments, the pump provides at least 2 L per minute.

In some embodiments, the one or more valves are one-way valves. In some embodiments, the one or more valves are three-way valves. The use of three-way valves can increase improve the overall power consumption of the device as well as form factor.

The valve response time is one of the largest unoptimized sources of delay. The second largest source of delay is the inflation and deflation of the fluid compartments. By increasing the pressure in the high pressure tank and decreasing the pressure in the negative pressure tank, the delay of inflating and deflating the fluid compartments can be minimized.

System Power

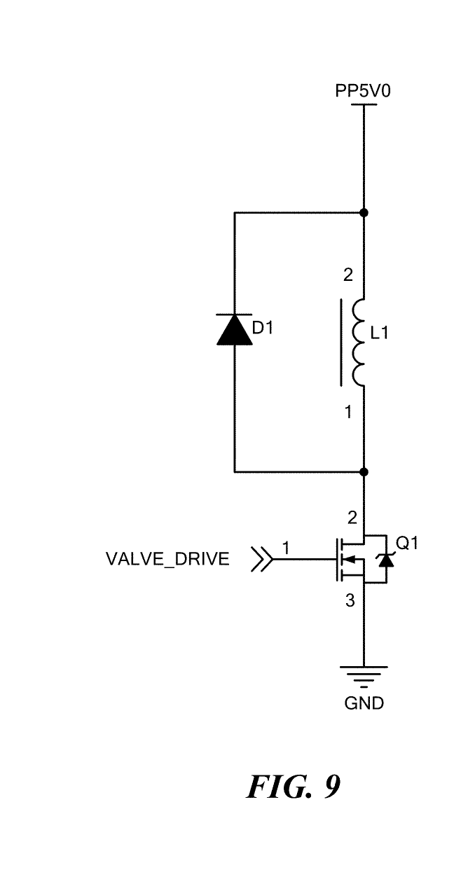

Regardless of an open or closed pressure topology being pursued, the system is designed to minimize delays in communication. FIG. 9 shows an embodiment of the invention in which a freewheeling diode is placed in parallel with the solenoid to reduce the inductive voltage spike generated by each actuator, and a microcontroller controls a low side switching FET which fires the valve.

The device can be portable or static. In some embodiments, the device is battery powered. In some embodiments, the device is powered from an electric outlet.

System Logic, Communication and Pressure Sensing Circuitry

In some embodiments, the device hardware includes a controller. The controller can be configured to control the activation and deactivation, as well as the magnitude of activation, of the actuating mechanism. The controller can be configured to receive haptic feedback data from an external source, such as a computing device. Examples of suitable controllers include Arduino boards and Atmel chips.

The pressure in each pouch with relation to ambient can be obtained with differential pressure sensors. The sensors enable the device to regulate to variable inflation levels based on the amount of virtual force in each virtual collision. Therefore, instead of a binary, on/off sensation, the device can reproduce variable amount of force being applied on a user. In some embodiments, when a virtual collision occurs, a series of pressures are determined for each fluid compartment and sent to the microcontroller over an appropriate coding scheme; the compartments then inflate until the pressure sensor for each compartment determines the inflation has occurred to the appropriate level.

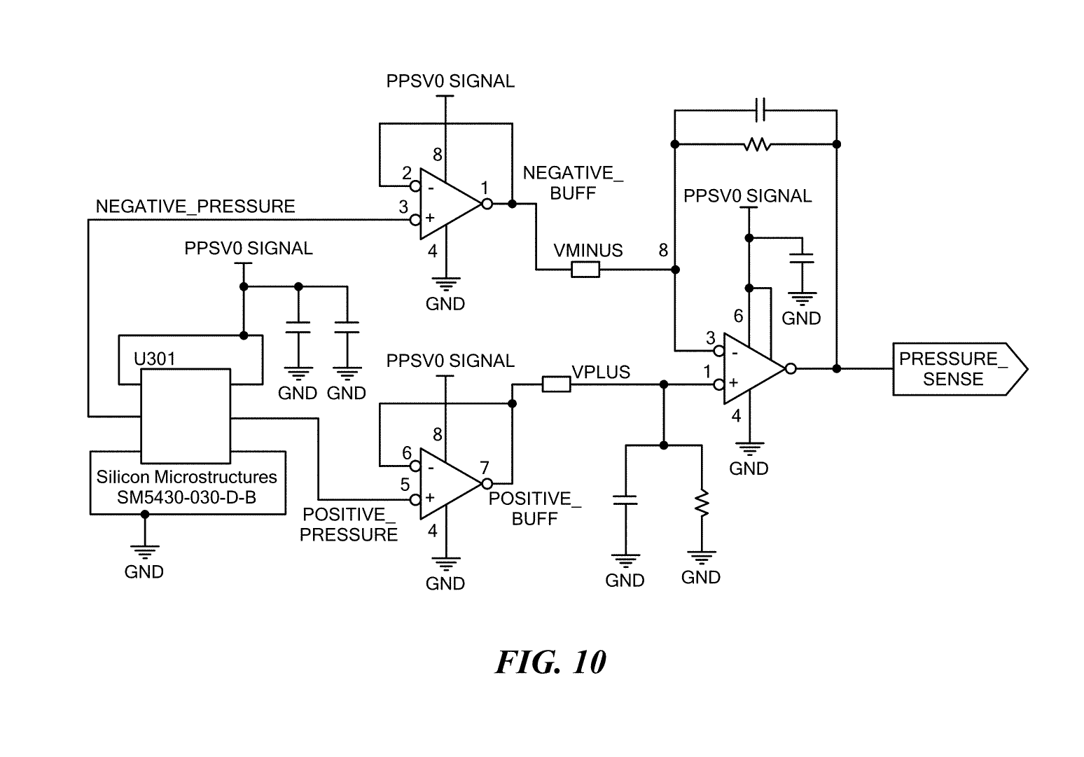

In some embodiments, an amplifier is used to ensure robust readout of the pressure sensor values. FIG. 10 shows a schematic representation of an embodiment of a two-stage stage amplifier between s differential pressure sensor and the microcontroller.

Printed Circuit Board Design

In some embodiments, the hardware includes one or more printed circuit boards (PCB). In some embodiments, the circuits are divided among two or more PCBs that can be stacked in order to obtain the most compact form factor. In some embodiments, components are placed on both sides of each board to make PCB design even more compact.

In some embodiments, the hardware includes two separate PCBs, the first including a main board housing the microcontroller, the voltage regulators and the sensing and amplification circuitry, and the second including valve boards populated with a set of actuators to control each individual fluid compartment. Such design allows the system to be scalable based on each application. If a greater number of fluid compartments is desired in order to obtain a greater tactile resolution, additional valve boards can be connected it with the main board, via ribbon cable, for example. The scalability also provides for more affordable solutions aimed at applications that require lower tactile resolution (for example, just sensation on the fingertips) which could require only one valve board.

In some embodiments, the main board is a four layer board with two signal routing layers and two separate ground layers. In some embodiments, the valve boards are simpler two layer boards. In some embodiments, two separate ground planes are used on the main boards to further isolate the sensing circuitry and microcontroller from potential noise generated by the buck regulator and from inductive noise created by the valves.

In some embodiments, the PCBs are mounted on the device. In some embodiments, the PCBs are not mounted on the device, but are connected to it via adequate cables. In one example, the device is a glove and the PCBs are mounted on the dorsal surface of the glove, or at the region corresponding to the wrist of the user.

Software

The software is designed to regulate inflation of fluid compartments while minimizing latency. If latency is too great and there is any perceptible delay between a user contacting a virtual or remote object and the user being provided tactile feedback, the system becomes compromised, as it does not allow the user to more intuitively engage with the virtual or remote environment. In some embodiments, the software minimizes latency by setting a busy flag based on a calculated inflate/deflate time based on the pressure difference between the current pressure of the pouch and the target pressure sent to the microcontroller in a series of bytes via wireless schemes—as opposed to reading all sensors every loop. In such embodiment, when the calculated inflate/deflate time is reached, the pressures at the appropriate fluid compartments are checked and corrected if the pressure has overshot or undershot the desired pressure within margin. A flow chart of an embodiment of the logic used to determine when to read the pressure in each fluid compartment is shown in FIG. 11.

The code can include any wireless schemes. Examples of suitable wireless schemes includes Serial and Bluetooth. In some embodiments, a string of bytes is sent out with the appropriate two byte header and two byte footer to be parsed by the microcontroller pressure regulation.

Virtual or Remote Environment

Any suitable virtual or remote environment can be used with the present invention. In some embodiments, one or more cameras can be configured to capture images of a user wearing the device to determine the user's location and movements. In some embodiments, the device includes a light that can be tracked to determine the user's location and movements. In some embodiments, the one or more cameras are infrared cameras, depth cameras, stereoscopic pair of cameras, or a combination thereof. In some embodiments, the captured positions of a user's body, pressures sensed, body parts touched and/or gestures and expressions are used to interact in a virtual reality scene, an augmented reality application or with another user or tool in a remote location. In some embodiments, the virtual environment is a video game and the user's captured positions affect a video game character. In some embodiments, the remote environment is a medical procedure and the user's captured positions affect a robotic control.

A skilled artisan will recognize that the uses of a haptic feedback device that includes one or more sensors, can detect pressure and capture's a user position can provide for a wide array of uses. The present invention can be used for video-gaming, rehabilitation, travel and exploring activities, and robotic control applications, among other uses. In some embodiments, the invention can be used by multiple users at the same time.

In one aspect, the invention is a system for providing haptic feedback to a user, the system including a computing device configured to generate tactile feedback data in addition to the device of invention. The computing device can be a laptop or desktop computer, a videogame console, a virtual reality apparatus or any other computing device capable of generating haptic feedback data.

### EXAMPLES

### Example 1

### Glove Design

Heat sealed high impact polyethylene pouches sized to cover the surface area of each phalange of the hand were placed around the glove over the location of each corresponding phalange (12 in total). An additional two pouches were placed over the palm of the hand on the liner. A second nylon liner was placed over the pouches and sewn to the first liner to create a physical glove with inflatable pouches. Notches were cut in the second liner to allow for pneumatic cables to run between each pouch and the device. High impact polyethylene was chosen due to its tear resistance to allow the design to survive transport and careless use by a user as well as minimize the chances of rupture over frequent inflation/deflation cycles. The heat seal on the polyethylene as well as the plastic itself is rated to 30 psi which is far greater than the required 8 psi to feel that the pouch is fully inflated. 8 psi was experimentally determined to be the pressure where a user can't feel air moving around within the pouch while moving their hands about and even while attempting to push down on a hard surface. An image of a single heat sealed pouch prior to being enclosed in the two liners is shown in FIG. 1.

### Example 2

### Pneumatic Hardware

Pneumatic cables were connected to each pouch through a barbed fitting that protrudes through the pouch. Plastic epoxy was used to seal the air gaps between the fitting and the pouch. This fitting was designed to maintain a secure and airtight hold on pneumatic cabling. Barbed fittings were chosen since they come in smaller form factors than push to connect pneumatic fittings and tend to be less rigid, allowing for an overall smaller form factor to make the glove feel less clunky and more light. The cables were organized into bundles and routed over the back of the glove to the device since the application only tracked the front of the hand.

### Example 3

### Pneumatic Pumps and Actuators

The structure of an open system is shown in FIG. 4. Air was compressed into a high pressure tank through a diaphragm pump, and an additional tank was connected to the vacuum end of the pump to create a negative pressure tank. A series of one way valves allowed air from the high pressure tank into each pouch for inflation during a virtual collision. An additional series of one way valves allowed for air to flow out of each pouch into the negative pressure tank when the user was no longer making contact with a virtual object. An additional valve released air drawn into the negative pressure tank to ambient, then the pump restored a vacuum in the negative pressure tank. Response times were between 25-30 ms.

A 12V Parker BTC high flow miniature diaphragm pump was chosen to pressurize the system. The pump can support up to 30 psi and has a high flow rate of up to 6 L per minute, thus ensuring a fast tank refill rate; however, a pump rated up to 10 PSI should perform roughly the same for a similar application. Such flow rate was desirable to ensure realistic tactile feedback even in situations where a user is frequently making contact with a virtual object, such as playing virtual bongo drums, in which case air would frequently be released to ambient after each impact on the drum. Overall, the total volume of the pouches on the glove was 9 mL and the tanks were designed to contain 2 L of air. Assuming a user is fully inflating and deflating all of the pouches once a second, that amounts to a loss of half a liter per minute. Therefore, a flow rate of 1 L per minute is the minimum required for the user to notice no perceptible change in pressure at a full deflation each second.

The valves were 28 low latency one way 5 V ASCO electric valves capable of standing up to 30 psi. The valves have a response time of 10 ms. The system was powered from an electric outlet, but could easily transition to battery power due to the small power requirements of the valves.

### Example 4

### System Power

The system was powered from an electric outlet. A buck converter was used to generate a 5 V power rail from the 12 V DC output of a standard laptop charger that plugs into a wall. This voltage was used to power the less sensitive valve circuitry where the greater priority is power delivery and not necessarily verifying signal integrity and reducing noise. A low dropout regulator (LDO) was used for the microcontroller and pressure sensing circuitry.

The overall power consumption of the prototype, which supported 14 pouches, was 11.5 Watts. The pump required 5 W and the valves required 6.3 Watts while the power consumed by the microcontroller, sensing circuitry, voltage regulators and switching circuitry were nearly negligible. Since the pump and valves were both highly oversized in terms of psi rating and flow requirements, significantly lower wattage components can be used for the pneumatic components to achieve the same device functionality.

### Example 5

### System Logic, Communication and Pressure Sensing Circuitry

An Arduino Mega was chosen to control the 26 valves due to its high IO count. However, Arduino is a single threaded microcontroller and cannot run multiple tasks simultaneously. To avoid delays, the software was used to introduce a delay that kept the device well below the 50 ms threshold.

Differential pressure sensors were used to obtain the pressure in each pouch with relation to ambient. These sensors enabled the device to regulate to variable inflation levels based on the amount of virtual force in each virtual collision. When a virtual collision occurred, a series of pressures were determined for each pouch and sent to the Arduino board over serial; the pouches on the device then inflated until the pressure sensor for each pouch determined that the inflation had occurred to the appropriate level. The pressure sensors output differential voltages over a full scale range of 165 mV, which needed to be amplified to the 1-3V readable range for the ADC on the microcontroller.

A two-stage amplifier was used to ensure a robust readout of the pressure sensor values. First, each line of the differential output was run through a voltage buffer and then through a differential amplifier with a gain of 10 and a cutoff frequency of 60 Hz. Since the system is completely DC and the sensors provide an analog readout, the cutoff frequency was chosen to be as low as possible to reduce the chances of ambient noise interfering with the integrity of the sensed values. 60 Hz was chosen as the cutoff to filter out any ripple that may be seen from the 60 Hz AC voltage from the wall in case the laptop block didn't create a sufficiently noiseless 12 V DC rail. A schematic of the two-stage amplifier is shown in FIG. 10.

### Example 6

### PCB Design

A stack of PCBs was designed to obtain the most compact form factor for the design. Two separate PCBs were designed for the system: a main board housing the micro-controller, the voltage regulators and the sensing and amplification circuitry; and valve boards populated with a set of solenoids to control 5 individual pouches. This was done to create a better form factor as well as allow for the system to be scalable based on each application. The main board is a four layer board with two signal routing layers and two separate ground layers while the valve boards are simpler two layer boards. Two separate ground planes were used on the main boards to further isolate the sensing circuitry and microcontroller from potential noise generated by the buck regulator and from inductive noise created by the valves.

### Example 7

### Software

The Arduino software was designed to regulate the pouch inflation while minimizing latency. The most resource intensive command of the Arduino is the AnalogRead( ) command that is run to obtain data from pressure sensors for every pouch. Since the system is not looking for patterns in a complex analog signal, but is instead looking for analog pressure levels, there was no need to read in large buffers of analog data. Since the ADC read error that may be caused by increasing the Arduino clock is not significant when looking at such a small buffer of data, the Arduino prescaler was changed so the clock would operate at 1 MHz instead of the typical 125 kHz. To minimize calls on the AnalogRead( ) function, instead of reading all of the sensors every loop, a busy flag was set based on a calculated inflate or deflate time based on the pressure difference between the current pressure of the pouch and the target pressure sent to the Arduino in a series of bytes via Serial. When this time was reached, the pressures at the appropriate pouches were checked and compensated for if the pressure has overshot or undershot the desired pressure within margin. A flow chart of the logic used to determine when to read the pressure in each pouch is shown in FIG. 11.

### Example 8

### Virtual Environment

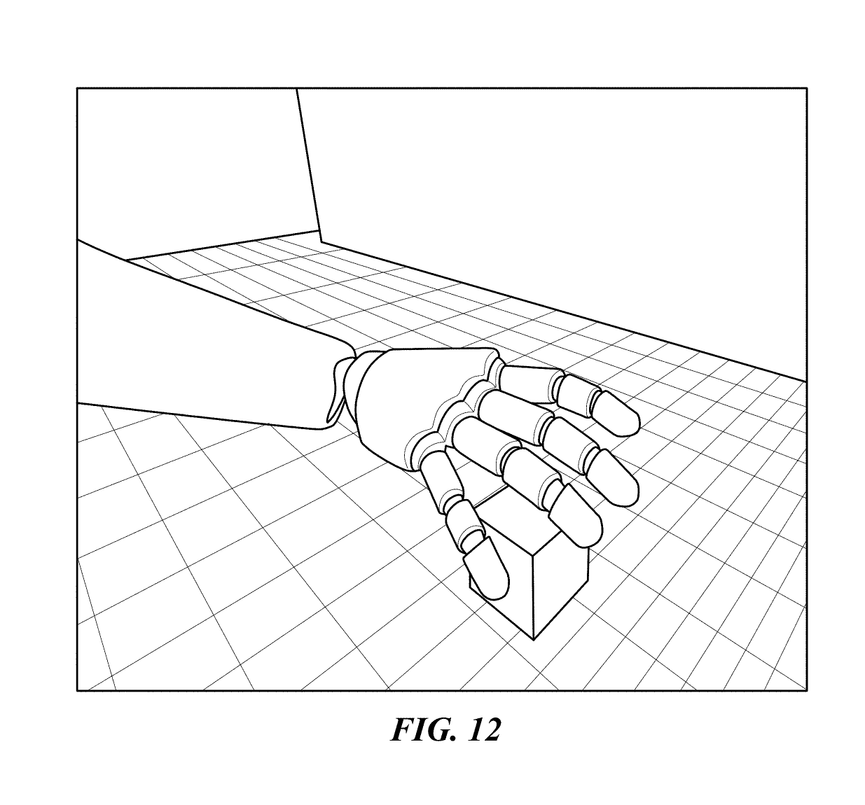

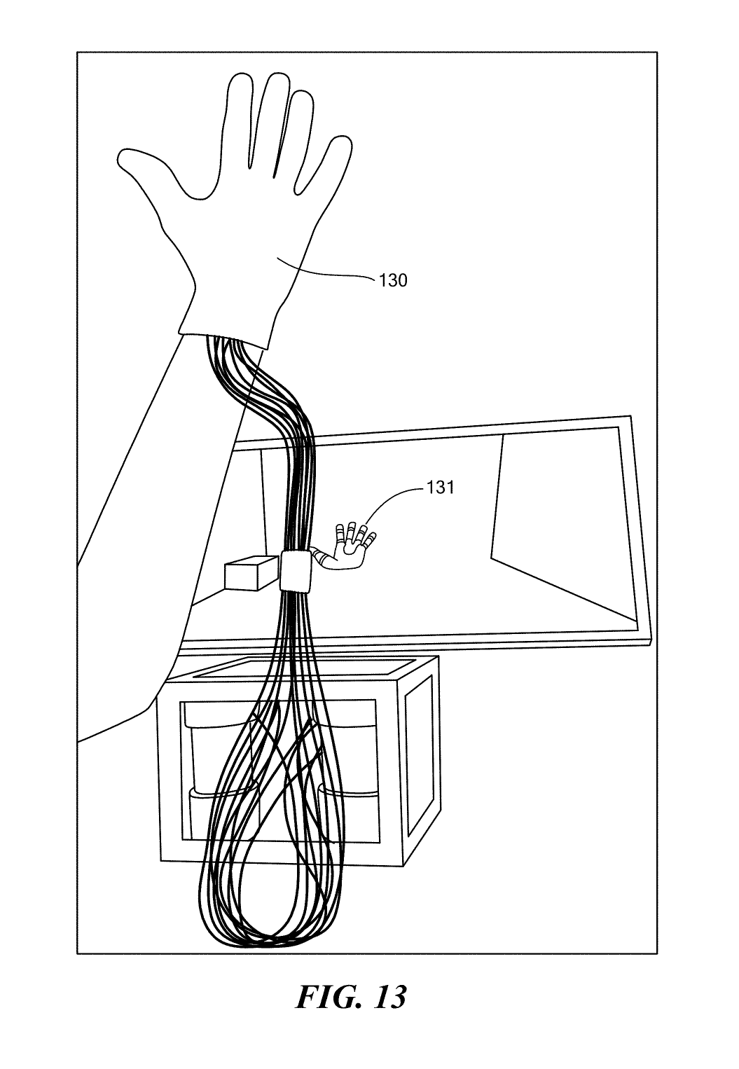

A virtual environment was created using Leap Motion SDK available for Unity. The virtual environment included a series of rendered objects for the user to grasp and manipulate (FIG. 12). Leap Motion tracked the users hand and when a digit of each hand or a quadrant of the palm collided with these virtual objects, using Unity's built in collision engine, a byte was populated corresponding to the pouch that should inflate or deflate and the level it should inflate or deflate to. FIG. 13 shows the image of a user's hand 130 being tracked by Leap Motion 131. A hexadecimal serial buffer was populated beginning with a predetermined two byte header and sent out at a rate of 60 Hz since Unity can be optimized to run at 60 frames per second. The serial buffer additionally has two closing footer bytes to reduce potential parsing errors.

What is claimed is:

1. A haptic feedback device comprising:
a wearable article comprising a substrate disposed to be worn by a user; and
a plurality of fluid compartments disposed on the substrate to independently exert a variable pressure on the user, each fluid compartment including a port connectable for fluid communication to a variable pressure source.

2. The device of claim 1, wherein the variable pressure source comprises a high pressure reservoir and a lower pressure reservoir.

3. The device of claim 1, further comprising one or more actuators in communication with the variable pressure source and operative to supply and remove a fluid from each fluid compartment.

4. The device of claim 1, further comprising a controller in communication with a plurality of pressure sensors associated with each fluid compartment, and configured to control a flow of fluid from the variable pressure source into and out of each fluid compartment to vary pressure within each fluid compartment.

5. The device of claim 1, wherein the fluid is air.

6. A haptic feedback system comprising:
a wearable article comprising a substrate disposed to be worn by a user, a plurality of fluid compartments disposed on the substrate to exert a variable pressure on the user;
one or more fluid pathways disposed between each of the fluid compartments and a fluid source;
a plurality of pressure sensors, each pressure sensor associated with one of the fluid compartments to sense a fluid pressure within the associated fluid compartment;
an actuating mechanism in communication with the fluid source and operative to supply and remove a fluid from each fluid compartment through the one or more fluid pathways; and
a controller in communication with the actuating mechanism and the plurality of pressure sensors associated with each fluid compartment, the controller configured to control a flow of fluid from the fluid source into and out of each fluid compartment to vary pressure within each fluid compartment

7. The system of claim 6, further including the fluid source, wherein the fluid source comprises a variable pressure source in fluid communication with each of the fluid compartments.

8. The system of claim 7, wherein the variable pressure source comprises a high pressure fluid reservoir disposed to provide a fluid to one or more of the fluid compartments to increase pressure therein, and a low pressure fluid reservoir disposed to receive fluid from one or more of the fluid compartments to decrease pressure therein.

9. The system of claim 6, wherein the one or more fluid pathways are in communication with an ambient environment to supply air to and remove air from the fluid compartments.

10. The system of claim 6, wherein the actuating mechanism includes valving disposed on a fluid pathway downstream of the high pressure fluid reservoir and actuatable to allow fluid to flow into one or more of the fluid compartments, and valving disposed on a fluid pathway upstream of the low pressure fluid reservoir and actuatable to allow fluid to flow out of one or more of the fluid compartments.

11. The system of claim 10, wherein the controller is configured to actuate the valving for a time determined to increase or decrease pressure in one of the fluid compartments, and to check a pressure reading in the fluid compartment to determine if a desired pressure has been reached.

12. The system of claim 6, wherein the actuating mechanism is operative to supply and remove a fluid from each fluid compartment within no more than 50 milliseconds.

13. The system of claim 6, wherein the controller is operative to control the actuating mechanism to supply and remove a fluid from each fluid compartment within no more than 50 milliseconds.

14. The system of claim 6, wherein the controller is in communication with a source of haptic feedback data, the haptic feedback data including at least data indicative of an external pressure change on the user, and the controller is operative to vary pressure within one or more of the fluid compartments to correspond to the external pressure change.

15. The system of claim 6, further comprising a fluid within the fluid compartments, wherein the fluid is a gas.

16. The system of claim 15, wherein the gas is air.

17. The system of claim 6, further comprising a fluid within the fluid compartments, wherein the fluid is water.

18. The system of claim 6, wherein the wearable article is a glove, a vest, a cap, a helmet, or a body suit.

19. The system of claim 18, wherein the wearable article is a glove, and the fluid compartments are disposed on fingers and a palm of the glove.

20. A method for delivering haptic stimuli to a user, the method comprising:
providing the haptic feedback system of claim 6,
in response to received haptic feedback data, actuating the actuating mechanism to supply a fluid to or remove a fluid from one or more of the fluid compartments to effect a variable pressure change for detection by the user.
